(19) United States
(12) Patent Application Publication
(10) Pub. No.: US 2012/0110490 A1
(43) Pub. Date: May 3, 2012

(54) DYNAMIC MENU FOR DEVICE SPECIFIC GRAPHICAL USER INTERFACE PRESENTATIONS

(75) Inventors: Michael R. Keller, Menomonee Falls, WI (US); Gregory W. Mears, Sussex, WI (US); Kelly Huttelmaier, Mequon, WI (US)

(73) Assignee: ROCKWELL AUTOMATION TECHNOLOGIES, INC., Mayfield Heights, OH (US)

(21) Appl. No.: 13/077,552

(22) Filed: Mar. 31, 2011

Related U.S. Application Data
(63) Continuation-in-part of application No. 13/032,353, filed on Feb. 22, 2011.
(60) Provisional application No. 61/408,481, filed on Oct. 29, 2010.

(51) Int. Cl. G06F 3/048

(52) U.S. Cl. 715/771

(57) ABSTRACT

A machine automation system for controlling a device in a machine automation environment is provided. The machine automation system includes a device and interface software. The interface software is configured to receive a selection of the device, display a control window associated with the device, identify at least one device specific menu item from a group of device specific menu items by querying each of the device specific menu items with a characteristic of the device to identify which of the device specific menu items should be displayed, and display the device specific menu item in the control window.

### RELATED APPLICATIONS

This application is a continuation in part of and claims priority to U.S. patent application Ser. No. 13/032353, entitled “Dynamic Loading of Device Feature Specific Graphical User Interface Presentations,” filed on Feb. 23, 2011, which claims priority to U.S. Provisional Patent Application No. 61/408,481, entitled “Dynamic Loading of Device Feature Specific Graphical User Interface Presentations,” filed on Oct. 29, 2010, and both of these applications are hereby incorporated by reference in their entirety.

### TECHNICAL FIELD

The subject matter described herein is related to the field of machine automation control products.

### TECHNICAL BACKGROUND

Machine automation environments include automobile factories, processing plants, fabrication facilities, assembly lines, and many other types of production and processing operations. The typical machine automation environment includes various devices such as pumps, drives, motors, starters, robots, programmable logic controllers (PLC), input/output (I/O) devices, sensors, actuators, automated tools, test instruments, or other devices, including combinations thereof. Devices in machine automation environments are commonly configured, controlled, and monitored by computers and software. In many cases, the software is implemented in the form of a graphical user interface (GUI). The options available in the software for configuring, controlling, and monitoring the devices may change based on the configuration of the machine automation environment, what devices are being used, or how the devices are being used.

Software updates may be necessary when the devices or the needs of the automation environment have changed. The needs of the automation environment may change because production needs have changed, because opportunities for improvement have been identified, because devices with new capabilities are installed, because devices are going to be used in a different manner, or for other reasons. The individual control options for each device may change because the state of the device has changed, because other devices are installed or removed, because a user's other configuration choices, or for other reasons. It is preferable to prohibit a user of the system from selecting those configuration options which are not presently applicable or appropriate for the device or system in order to simplify the configuration process, to minimize error, or for other reasons.

### OVERVIEW

A machine automation system for controlling a device in a machine automation environment is provided. The machine automation system includes a device and interface software. The interface software is configured to receive a device selection, display a control window associated with the device, identify at least one device specific menu item from a group of device specific menu items by querying each of the device specific menu items with a characteristic of the device to identify which of the device specific menu items should be displayed, and display the device specific menu item in the control window.

In some examples, the interface software is configured to query each of the device specific menu items with the characteristic of the device to identify which of the device specific menu items should be displayed.

In some examples, the characteristic of the device is a type of the device.

In some examples, the characteristic of the device is a status of the device.

In some examples, the interface software is configured to identify an alternative menu item in response to a change in the status of the device, load the alternative menu item, and display the alternative menu item in the control window.

In some examples, the interface software is configured to identify a standard menu item which is compatible with the device and other devices in the machine automation environment, load the standard menu item, and display the standard menu item in the control window along with the device specific menu item.

In some examples, the device specific menu item is modified without modifying the program instructions.

In some examples, the device specific menu item is displayed in the form of a push button, a radio button, an icon, selectable text, or a check box.

In some examples, the interface software is further configured to display a graphical window which is associated with the device specific menu item and contains information about the device in response to receiving a selection of the device specific menu item.

In some examples, the device specific menu item is displayed based on a feature or state of the machine automation environment.

A non-transitory computer readable medium having program instructions is also provided. The program instructions, when executed by a configuration system for controlling devices in a machine automation environment, direct the configuration system to receive a selection of at least one device, display a control window associated with the device, identify, based on a characteristic of the device, at least one device specific menu item from a group of device specific menu items, and display the device specific menu item in the control window.

A method is also provided. The method includes the steps of receiving a selection of at least one device from a group of devices, displaying a control window associated with the device, identifying, based on a status of the device, at least one device specific menu item from a group of device specific menu items, and displaying the device specific menu item in the control window.

A machine automation system including interface software and a server is also provided. The server is configured to transfer the interface software to a control platform. The interface software, when executed by the control platform, directs the control platform to receive a selection of at least one device, display a control window associated with the device, identify, based on a characteristic of the device, at least one device specific menu item, and display the device specific menu item in the control window.

A machine automation system including a database and interface software is also provided. The database contains device specific menu items. The interface software is configured to receive a selection of at least one device and display a control window associated with the device. The interface software is configured to then identify, based on a characteristic of the device, at least one device specific menu item in the database by querying each of the device specific menu items with the characteristic of the device to identify which of device specific menu items should be displayed, and display the device specific menu item in the control window.

### BRIEF DESCRIPTION OF THE DRAWINGS

FIG. 1 illustrates a machine automation system.

FIG. 2 illustrates a method of operating a machine automation system.

FIG. 3 illustrates a machine automation system in which interface software is transferred from a server for delivery to a control platform.

FIG. 4 illustrates a device level window.

FIG. 5 illustrates a process in which a device level window is configured.

FIG. 6 illustrates a GUI component window associated with an action button in a device level window.

FIG. 7 illustrates the selection and launch of a GUI component window.

FIG. 8 illustrates a control platform.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Devices in machine automation environments are commonly controlled by computers and software. In many cases, the software is implemented in the form of a graphical user interface (GUI). The software is used to configure, control, or monitor the devices, or combinations thereof. The options available for configuring, controlling, and monitoring the devices may change based on what type of devices are being used, how the devices are being used, what state the devices are in, the overall state of the machine automation system, which other devices are being used in the system, or for other reasons.

It is desirable for the software to only make available those options which are applicable to the current state of the device or the system. The determination of which options are applicable may be made when the software is loaded, when system operation begins, when a change in the system state occurs, when the state of a device changes, or at other times. In addition, it is desirable to add or change menu items without rewriting or recompiling the interface software.

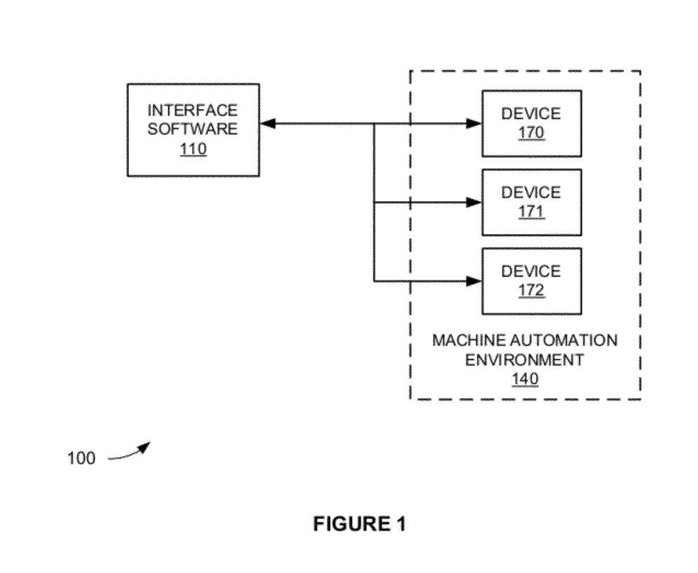

FIG. 1 illustrates machine automation system 100. Machine automation system 100 comprises interface software 110 and machine automation environment 140. Machine automation environment 140 comprises devices 170-172.

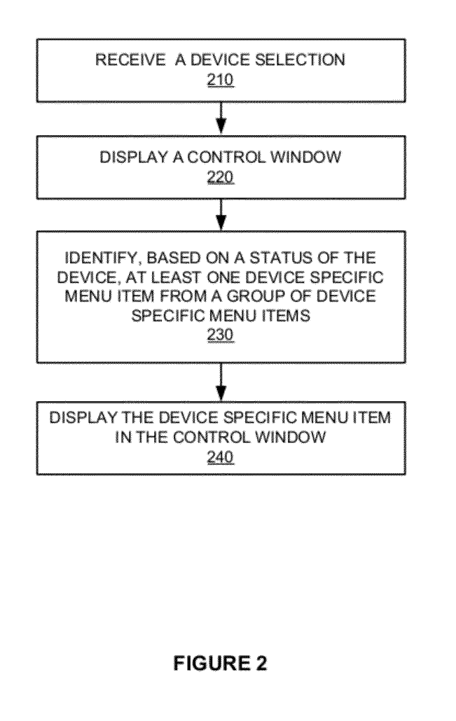

FIG. 2 illustrates an example of operation of machine automation system 100. The steps of the operation are indicated below parenthetically. Interface software 110 receives a device selection which, in this example, indicates selection of device 170 (210). Interface software 110 then displays a control window (220). Interface software 110 identifies, based on the status of device 170, at least one device specific menu item from a group of device specific menu items (230). Finally, interface software 110 displays the device specific menu item in the control window (240).

Referring back to FIG. 1, interface software 110 comprises instructions and related data which, when executed by a processor, allow a user to configure, control, or monitor any of devices 170-172. Machine automation environment 140 may be in a manufacturing, assembly, production, processing, or other similar environment where devices, like devices 170-172, are used to perform processes.

Devices 170-172 operate in machine automation environment 140 and communicate with interface software 110. Devices 170-172 may comprise a pump, a drive, a motor, a starter, a robot, a PLC, an I/O device, a sensor, an actuator, an automated tool, a test instrument, or other device, including combinations thereof, which can be configured, operated, or monitored using interface software 110.

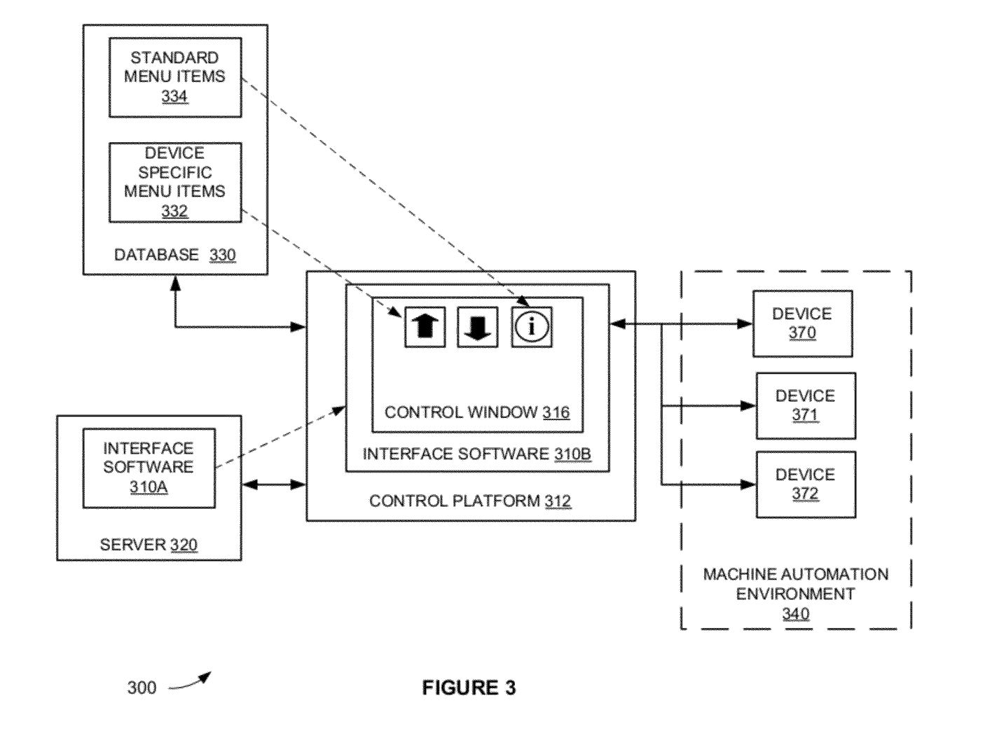

FIG. 3 illustrates machine automation system 300 which comprises control platform 312, server 320, database 330, and machine automation environment 340. In machine automation system 300, interface software is transferred from server 320 for delivery to control platform 312.

Server 320 comprises interface software 310A, a storage device, and an interface for transmitting software. Server 320 may be a computer, a web server, a database system, custom hardware, or other similar computing device. Server 320 may also comprise a user interface, other software, communication components, a power supply, or structural support.

In one example of operation, server 320 is configured to transmit interface software 310A for delivery to control platform 312. Control platform 312 comprises interface software 310B, a processor, and an interface for communicating with other devices. Control platform 312 may also comprise a user interface, a processor, memory, other software, communication components, a power supply, or structural support. Control platform 312 may be a computer, a server, a control panel, custom hardware, or other type of computing device.

Interface software 310B is an instance of interface software 310A and is executed by control platform 312. Interface software 310B may be a duplicate copy of interface software 310A or may be a customized version with certain options, features, or modules disabled, modified, or removed. Both interface software 310A and interface software 310B are examples of interface software 110 although they may have alternate configurations or operate in alternate manners.

The process of transmitting interface software 310B to control platform 312 may be performed over an Internet, an intranet, a wireless link, or another type of communication network. The transfer may also include additional steps including purchase of interface software 310B, acceptance of a user agreement, selection of support options, or other transactional steps.

When executed on control platform 312, interface software 310B displays control window 316 which is associated with a device in machine automation environment 340, device 370 in this example. Interface software 310B directs control platform 312 to identify at least one device specific menu item in database 330 based on a characteristic of device 370. The characteristic of device 370 may be the type, the model, the status, or a feature of device 370.

Database 330 comprises device specific menu items 332, standard menu items 334, and an interface for transmitting menu items. Database 330 may be a server, a computer, a database, or storage system which is capable of providing menu items and transmitting them in response to requests from control platform 312. The menu items contained in database 330 are software programs, widgets, or modules which may be used by interface software 310B to implement menu items in control window 316. Standard menu items are menu items which are applicable to multiple types of devices. In some cases, multiple menu items will be selected and displayed for each device. A single control window may also contain both device specific menu items and standard menu items.

It should be understood that database 330 may be implemented in various manners and in multiple locations, including implementation as a component of other parts of machine automation system 300. For example, database 330 may be implemented in server 320 or control platform 312.

Displaying menu items, either device specific or standard menu items, may involve displaying a push button, a radio button, an icon, selectable text, a check box, or some other type of graphical element in control window 316. Some menu items are not only device specific but may be specific to particular device states. For instance, a menu item may only be applicable to device 370 and will only be loaded if device 370 is in a particular state. Selecting the menu items based on characteristics of device 370 other than status, including combinations thereof, is also possible. In addition, selecting menu items based on the status or configuration of machine environment 340, or related systems or subsystems, is also possible. The standard menu items may be applicable to multiple types of devices in machine automation environment 340 or all of the devices in machine automation environment 340.

The process of identifying which specific menu items will be selected and displayed involves individually querying the device specific menu items in database 330 with the status of device 370 to determine if each of the device specific menu items is applicable to device 370 or its current state. Each device specific menu items contains information relating to its applicability to or compatibility with device 370, the status of device 370, or some other characteristic of device 370. In response to the query, each device specific menu item provides information indicating whether it is applicable. The device specific menu item is either displayed or not displayed in control window 316 based on this information.

For any combination of devices and states in machine automation environment 340, interface software 310B does not need to contain information about which menu items are applicable or retrieve this information from another location because the information is contained in the menu items. The process of determining all of the applicable menu items may involve interface software 310B querying multiple menu items within database 330. Although standard menu items are applicable to multiple devices, they may also contain information regarding which devices or device states they are applicable to and may be queried in a manner similar to that for the device specific menu items.

When a device specific menu item associated with device 370 is selected by a user, interface software 310B performs a function associated with device 370. This function may include displaying a graphical window which is associated with the selected menu item and contains information about device 370.

It should be understood that multiple control windows may be associated with a single device. It should also be understood that one type of control window may be associated with multiple devices and a single instance of that control window may be associated with multiple devices.

In one example of operation of machine automation system 300, control platform 312 may not be required to retrieve menu items from a separate location or system, like database 330. In this example, machine automation system 300 operates as described above, with the exception that the device specific menu items, the standard menu items, or both, are available within control platform 312.

In another example of operation of machine automation system 300, control platform 312 may already contain interface software 310B and may not have to receive, access, or download it from server 320.

In yet another example of operation of machine automation system 300, control platform 312 does not receive or contain interface software 310B. In this example, control platform 312 performs the functions described above by remotely utilizing or executing interface software 310A, or a similar software program, on server 320. The remote use of interface software 310A may occur by use of a web browser or other type of network interface.

In any of the examples above, interface software 310A or 310B may also direct control platform 312 to update the menu items displayed and available to a user of control platform 312 in interface software 310B. Updating may involve removing menu items, identifying additional menu items, displaying additional items, refreshing menu items, or a combination thereof.

Menu items or other graphical items associated with devices 370-372 may be updated in response to a change in status of any of devices 370-372. The menu items may also be updated in response to the addition or removal of other devices in machine automation environment 340 or a change in status of other devices in machine automation environment 340. The menu items may also be updated when the user makes a selection or takes any other action associated with interface software 310B. The menu items may also be updated on a periodic basis regardless of, or in addition to, any device or system status changes.

The menu items available in database 330 are used by interface software 310B to present options to a user of interface software 310B in control window 316. Although these menu items work in conjunction with interface software 310B, they are separate from interface software 310B. Menu items are independent from interface software 310A and 310B and may be modified or added without modifying or recompiling interface software 310A or 310B.

Interface software 310A and 310B is written and compiled in a manner such that it is able to make use of menu items which were independently created or created after the compilation of interface software 310A and 310B. In this way, interface software 310A and 310B may be executable files which do not have to be modified or recompiled each time a menu item is modified or added. In some examples, menu items may operate like plug-ins or add-ons but have the added benefit of containing information about machine automation system 300, machine automation environment 340, or devices 370-372.

As described above, the menu items exist separately from interface software 310A and 310B and may be created separately from the interface software. Menu items may be created by the creator of interface software 310A or 310B. However, menu items may also be created by parties who are not the creators of interface software 310A or 310B. Control platform 312 or interface software 310A or 310B may include additional security features which validate, verify, scan, or otherwise check menu items before they are made available to or used by interface software 310B. For instance, the menu items may be checked for viruses, for compatibility, for authorship, for compliance with standards, or for other characteristics before being loaded and made available to users. The menu items may be given different levels of certification depending on how thoroughly they have been tested or verified, or based on the experiences of other users.

Database 330 may also be operated as a separate business activity. For example, users may pay for each menu item they download, buy, rent, or otherwise make use of from the database. Payment may allow permanent use of the menu item or may be a license for use for only a specified period of time. An author or submitter of a menu item may be paid a flat amount for inclusion of his menu item in the database or may be paid based on the number of purchases or uses of the menu item submitted. Other variations of this business method are possible.

The menu options which are available may also be varied based on tiers of permission levels and which tier a particular user belongs to. For example, when a user logs in to control platform 312, the options available to that user may be configured based on what permissions an administrator, or other controlling authority, has granted to that user.

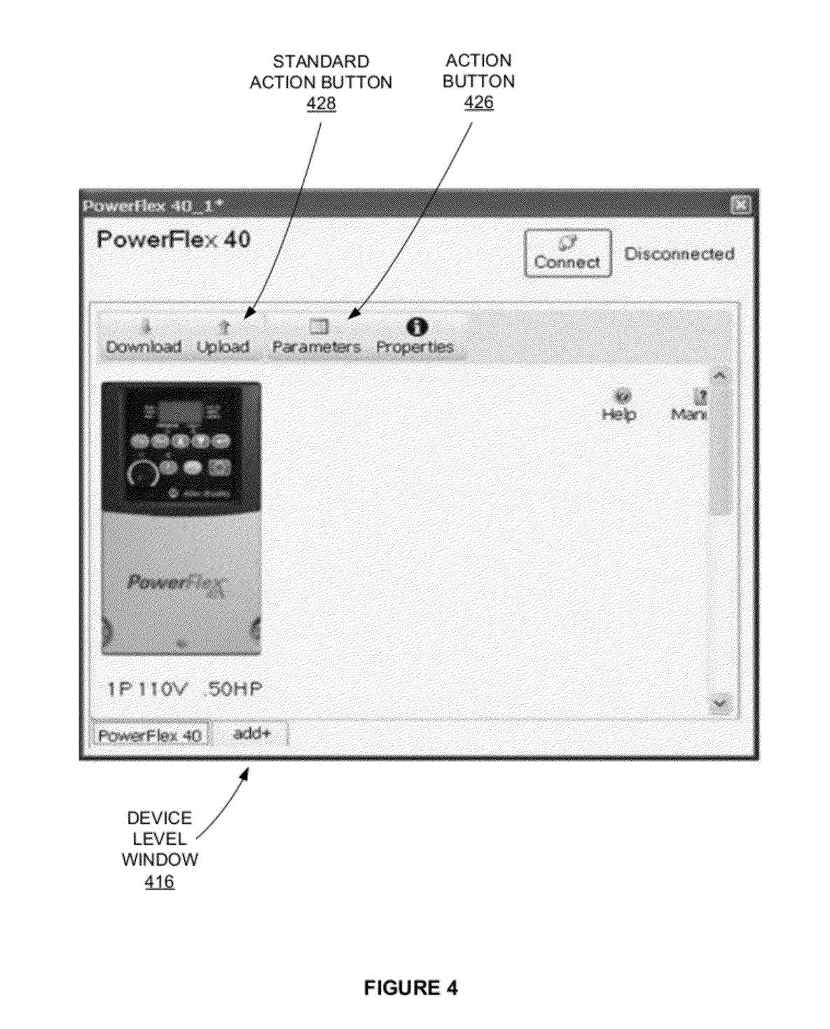

FIG. 4 illustrates a more detailed view of a control window associated with the interface software described above. In this example, the control window is illustrated as device level window 416. Device level window 416 is one example of control window 316 although other implementations or configurations are possible. In this example, device level window 416 is associated with a PowerFlex 40 device which is in a machine automation environment like machine automation environment 140 or 340. Device level window 416 is displayed by interface software like interface software 110, interface software 310A, or interface software 310B. Device level window 416 comprises action buttons related to the configuration, operation, or monitoring of the PowerFlex 40 device.

The action buttons illustrated in FIGS. 4-7 are examples of the device specific menu items and standard menu items discussed in the examples above. Many other implementations of device specific menu items and standard menu items are possible.

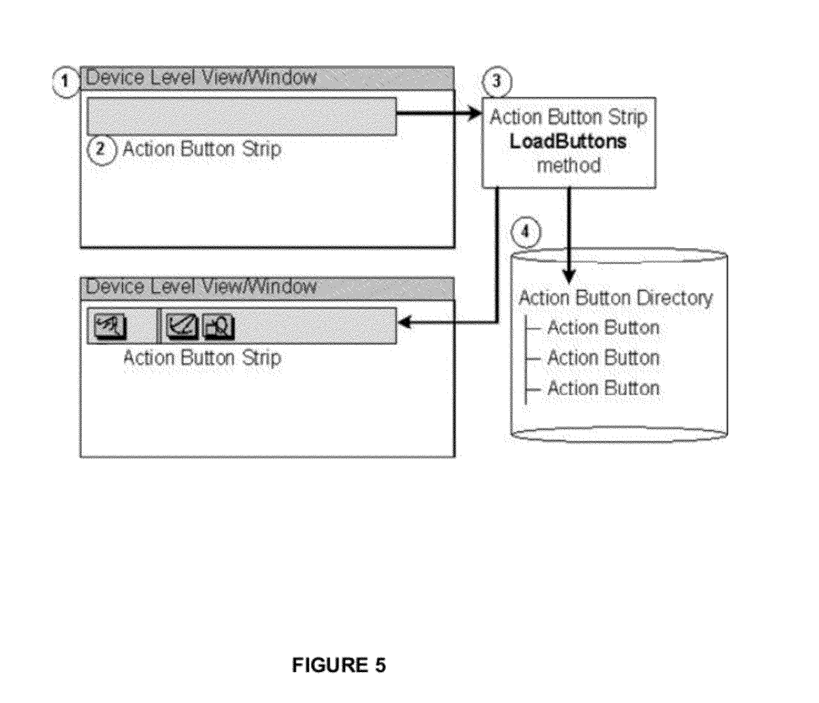

FIG. 5 illustrates a process in which device level window 416 is configured. The steps are indicated below parenthetically. The frame of device level window 416 is first displayed (1). Next, an action button strip is displayed (2). The action button strip is a sub-window or a region of the window which is dynamically loaded with action buttons. In this case, the action buttons are graphic images representing features, information, actions, or operations associated with the PowerFlex 40 device. The action buttons are implemented as buttons which may be invoked by selection or pressing within the user interface created by execution of the interface software.

A software operation, an operation called LoadButtons in this example, is executed to select and load the action buttons (3). This software may be contained within the action button strip. The action buttons are selected from an action button directory, database, or database based on the PowerFlex 40 device features and system status information (4). One or more of the action buttons in the database is queried to determine if each action button is applicable to the device and device status. The status information may include information about whether the device or system is online, offline, faulted, running, or other states.

As described in previous examples, the action buttons contain or have access to information indicating whether they are each applicable to the PowerFlex 40 device, the current status of the PowerFlex 40 device, or the various system states described above. This may be accomplished by deriving the action buttons from a base .NET assembly that provides mechanisms for logic to be associated with the button or by other means. The appropriate action button or buttons are loaded into the action button strip such that the only action buttons which are available to the user are those buttons which are applicable to the current devices, device state, system configuration, or system state.

The action buttons described above are specific to the PowerFlex 40 device. One example of this type of device specific action button is action button 426 in FIG. 4. The action button strip may also contain standard action buttons. A standard action button may apply to many or all of the devices in a machine automation environment. As a result, a single instance of a standard action button may be loaded into device level windows for multiple devices. Standard action button 426 is an example of a universal action button and selection of this button causes the interface software to upload parameters to a device, the PowerFlex 40 device in this example. The standard buttons may also be selected and loaded as part of a process similar to that illustrated in FIG. 5.

In another example of operation, a standard action button may always be visible in the control window even if it cannot currently be selected or used. The standard button may be visible but grayed-out or otherwise temporarily deactivated.

When a state change occurs, the LoadButtons method is invoked with the new the state information. At this point, the LoadButtons method performs the operation of refreshing or reloading the action button strip with only those action buttons that apply to the device type and the current state. This update and reloading process may apply to both the device specific action buttons as well as the universal buttons. In one variation of this process, the LoadButtons method may query action buttons that are already loaded into the action button strip rather than attempting to reload them from the directory. If an existing action button supports the new state, then the action button may remain in the action button strip.

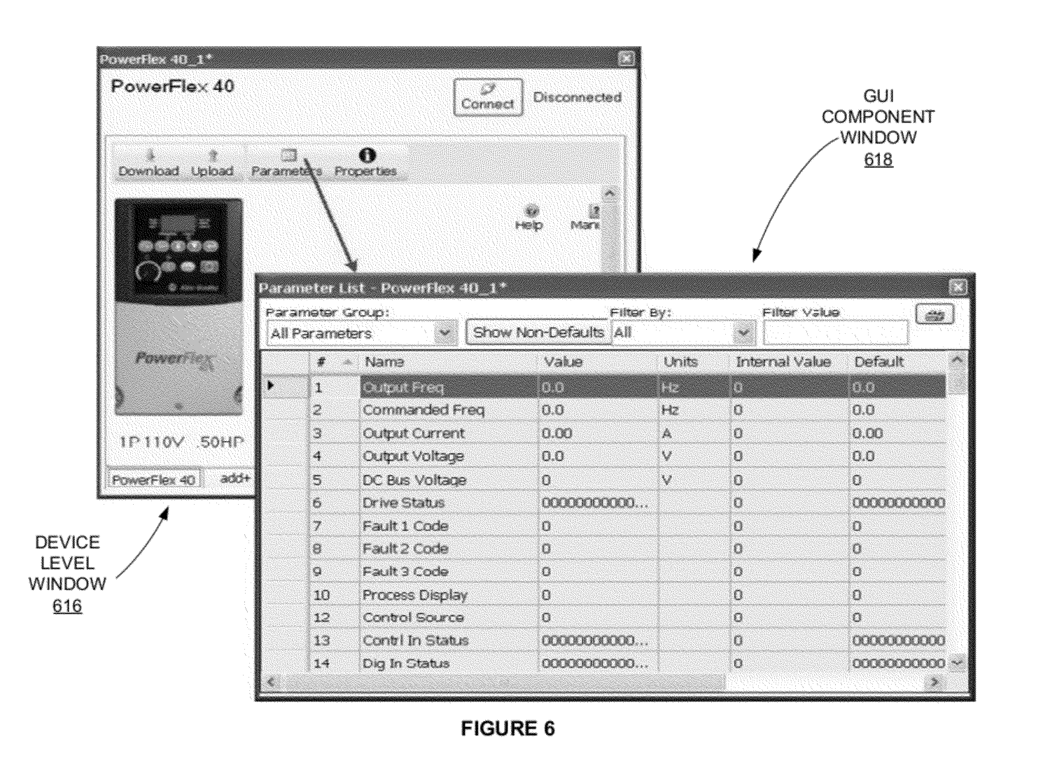

FIG. 6 illustrates GUI component window 618 which is associated with an action button in device level window 616. A GUI component window is a view, window, dialog box, or other graphical display of data which presents information associated with a device. In FIG. 6, GUI component window 618 displays parameters associated with the PowerFlex 40 device. In another example, a GUI component is associated with an action button and displays the faults which have occurred in a device when the action button is selected.

In some cases, a GUI component window which is currently open will be updated or removed when the associated menu item is updated or removed. For example, when a menu item is removed because of a change in device or system status, a GUI component window which was previously opened using that menu item will also be removed. In addition, a change in device or system status may cause the contents of a GUI component window to be updated.

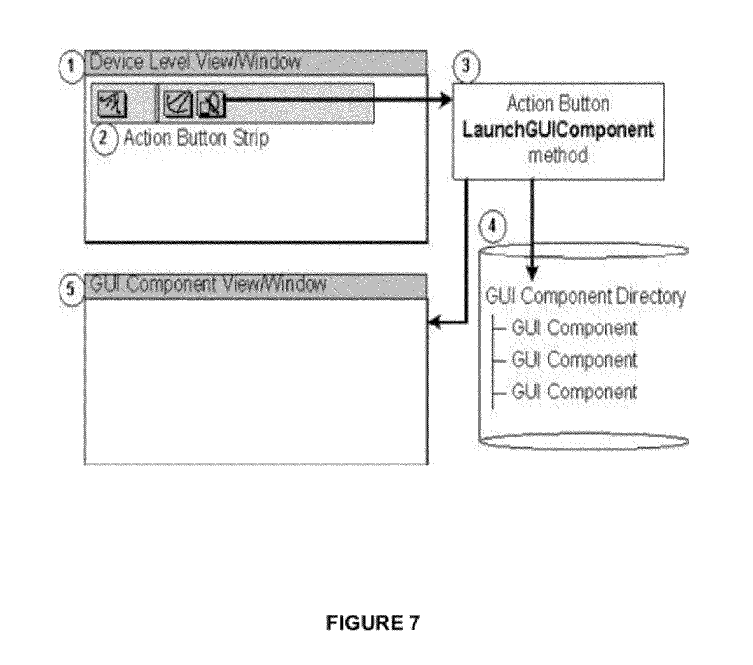

FIG. 7 illustrates the selection and launch of GUI component window 618. The steps of operation are indicated below parenthetically. The action buttons are chosen and displayed in the action button strip of device level window 616 as described with respect to FIG. 4 and FIG. 5 (1). When a user of the control platform clicks the ‘Parameter’ action button (2), a LaunchGUlComponent method within the action button is called (3). This method determines which specific GUI component in a directory is associated with the action button (4). In this case, GUI component window 618 is the window associated with the selected action button and is displayed in response to the selection (5). In this example, GUI component window 618 is a parameter list containing information about various operational parameters of the PowerFlex 40 device.

It should be understood that a single action button which appears in multiple device level windows may, when selected, invoke different GUI component windows based on the device associated with the window in which the action button was displayed. When the action button is clicked or otherwise selected, software in the action button that responds to the event will determine which specific GUI component window to launch based on the device type, the device status, or some other characteristic. It should also be understood that selection of an action button may also launch multiple GUI component windows or invoke other processes in the software system.

In a variation of the operation illustrated in FIGS. 6 and 7, selecting an action button may perform a function other than, or in addition to, the launch of a GUI component window. For example, selecting a ‘reset’ action button may reset a device. The reset process may not include display of any additional information to the user or may include a confirmation dialog box which is only temporarily present until the user confirms the operation.

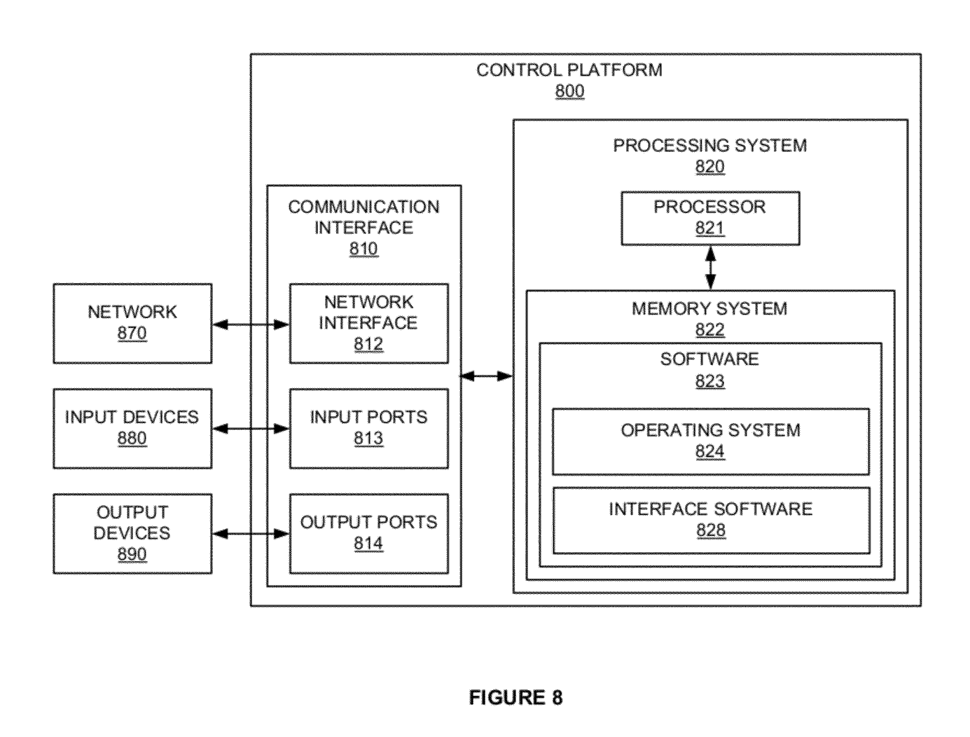

FIG. 8 illustrates control platform 800. Control platform 800 is an example of control platform 312. Control platform 800 includes communication interface 810 and processing system 820. Processing system 820 is linked to communication interface 810 through a communication link.

Communication interface 810 includes network interface 812, input ports 816, and output ports 814. Communication interface 810 includes components that communicate over communication links, such as network cards, ports, RF transceivers, or other communication devices. Communication interface 810 may be configured to communicate over metallic, wireless, or optical links. Communication interface 810 may be configured to use TDM, IP, Ethernet, optical networking, wireless protocols, communication signaling, or some other communication format, including combinations thereof. Control platform 800 may include multiple network interfaces.

Network interface 812 is configured to connect to external devices over network 870. Network interface 812 may be configured to communicate in a variety of protocols. Server 320, database 330, devices 170-172, and devices 370-372 are examples of external devices. Input ports 816 are configured to connect to input devices 880 such as a storage system, a keyboard, a mouse, a user interface, or other input device. Output ports 814 are configured to connect to output devices 890 such as a storage system, other communication links, a display, or other output devices.

Processing system 820 includes processor 821 and memory system 822. Processor 821 includes microprocessor or other circuitry which retrieves and executes operating software from memory system 822. Memory system 822 comprises software 823. Memory system 822 may be implemented using random access memory, read-only memory, a hard drive, a tape drive, flash memory, optical storage, or other memory apparatus.

Software 823 comprises operating system 824 and interface software 828. Interface software 828 is an example of interface software 110, interface software 310A, or interface software 310B, although interface software 828 may have an alternate configuration or operate in an alternate manner. Software 823 may also comprise additional computer programs, firmware, or some other form of non-transitory, machine-readable processing instructions.

When executed by processor 821, operating system 824 directs processing system 820 to operate control platform 800 as described herein using interface software 828. For example, interface software 828 directs control platform 800 to receive a device selection, display a control window, identify a device specific menu item, and display the device specific menu item in the control window.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A non-transitory computer readable medium having program instructions stored thereon that, when executed by a configuration system for controlling a plurality of devices in a machine automation environment, direct the configuration system to:
receive a selection of at least one device of the plurality of devices;
display a control window associated with the device;
identify, based on a characteristic of the device, at least one device specific menu item of a plurality of device specific menu items; and
display the device specific menu item in the control window.

2. The computer readable medium of claim 1 wherein the program instructions identify the device specific menu item by further directing the configuration system to:
query each of the plurality of device specific menu items with the characteristic of the device to identify which of each of the plurality of device specific menu items should be displayed.

3. The computer readable medium of claim 1 wherein the characteristic of the device comprises a type of the device.

4. The computer readable medium of claim 1 wherein the characteristic of the device comprises a status of the device.

5. The computer readable medium of claim 4 wherein the program instructions further direct the configuration system to:
identify an alternative menu item in response to a change in the status of the device;
load the alternative menu item; and
display the alternative menu item in the control window.

6. The computer readable medium of claim 1 wherein the program instructions further direct the configuration system to:
identify a standard menu item which is compatible with the device and other devices in the machine automation environment;
load the standard menu item; and
display the standard menu item in the control window along with the device specific menu item.

7. The computer readable medium of claim 1 wherein the device specific menu item is modified without modifying the program instructions.

8. The computer readable medium of claim 1 wherein the device specific menu item is displayed in a form of one of: a push button, a radio button, an icon, selectable text, or a check box.

9. The computer readable medium of claim 1 wherein the program instructions further direct the configuration system to:
display a graphical window which is associated with the device specific menu item and contains information about the device in response to receiving a selection of the device specific menu item.

10. A method comprising:
receiving a selection of at least one device of a plurality of devices;
displaying a control window associated with the device;
identifying, based on a status of the device, at least one device specific menu item of a plurality of device specific menu items; and
displaying the device specific menu item in the control window.

11. The method of claim 10 wherein identifying the device specific menu item further comprises:
querying each of the plurality of device specific menu items with the status of the device to identify which of each of the plurality of device specific menu items should be displayed.

12. The method of claim 10 further comprising:
identifying an alternative device specific menu item in response to a change in the status of the device;
loading the alternative device specific menu item;
removing the device specific menu item from the control window; and
displaying the alternative device specific menu item in the control window.

13. The method of claim 10 further comprising:
identifying a standard menu item which is compatible with the device and other devices of the plurality of devices;
loading the standard menu item; and
displaying the standard menu item in the control window.

15. The method of claim 10 wherein the device specific menu item is modified without modifying the device interface.

16. The method of claim 10 wherein the device specific menu item is displayed in a form of one of: a push button, a radio button, an icon, selectable text, or a check box.

17. A machine automation system comprising:
a device in a machine automation environment comprising a plurality of devices; and
interface software configured to:
receive a selection of the device;
display a control window associated with the device;
identify at least one device specific menu item of a plurality of device specific menu items by querying each of the plurality of device specific menu items with a characteristic of the device to identify which of each of the plurality of device specific menu items should be displayed; and
display the device specific menu item in the control window.

18. The machine automation system of claim 17 wherein the characteristic of the device comprises a type of the device or a status of the device.

19. The machine automation system of claim 17 wherein the device specific menu item is modified without modifying the interface software.

20. The machine automation system of claim 17 wherein the device specific menu item is displayed in a form of one of: a push button, a radio button, an icon, selectable text, or a check box.

21. A machine automation system for controlling a plurality of devices in a machine automation environment comprising:
interface software; and
a server configured to transfer the interface software for delivery to a control platform wherein the interface software, when executed by the control platform, directs the control platform to:
receive a selection of at least one device of the plurality of devices;
display a control window associated with the device;
identify, based on a characteristic of the device, at least one device specific menu item of a plurality of device specific menu items; and
display the device specific menu item in the control window.

22. A machine automation system for controlling a plurality of devices in a machine automation environment comprising:
a database containing a plurality of device specific menu items; and
interface software configured to:
receive a selection of at least one device of the plurality of devices;
display a control window associated with the device;
identify, based on a characteristic of the device, at least one device specific menu item in the database by querying each of the plurality of device specific menu items with the characteristic of the device to identify which of each of the plurality of device specific menu items should be displayed; and
display the device specific menu item in the control window.
